(19) United States
(12) Patent Application Publication
(10) Pub. No.: US 2005/0060190 A1
(43) Pub. Date: Mar. 17, 2005

(54) Pre-agreed estate settlement plan

(76) Inventor: Richard A. Cahill, Aston, PA (US)

Correspondence Address: RICHARD CAHILL, 712 A DRAYTON RD., ASTON, PA, 19014, US

(21) Appl. No.: 10/663,135

(22) Filed: Sep. 16, 2003

(51) Int. Cl. G06F 17/60

(52) U.S. Cl. 705/2

(57) ABSTRACT

The attached patent application is made for a new business process, titled Pre-Agreed Estate Settlement Plan, which would provide an alternative not currently available to any person or married couple holding assets of any valuable nature and anticipating his/her/their demise and the transfer of said assets to his/her/their heirs-a predetermined-cost method of transferring assets from deceased individuals to their beneficiaries.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention, a business process, creates a fixed-cost method of transferring assets from deceased individuals to their beneficiaries.

### BACKGROUND OF THE INVENTION

The traditional and typical method of transferring assets from deceased individuals to their heirs has been the will and probate system. If no will of a deceased person exists or may be found, then assets of the deceased are probated according to each state's rules for intestate descent. This system exists in all fifty states, and in most states the cost and the length of time the process consumes is highly uncertain. Even in states which have set probate costs, such as California, the size of the estate, which is the term by which the assets left behind by a deceased individual or married couple are known, and the difficulty of settlement, which is the term by which the process of transferring said assets to the deceased beneficiaries is known, determines the cost, and that cost is considerably higher than settling the estate by non-probate means. The size of the estate is determined after death, so the cost of probate cannot be accurately anticipated by the individual or married couple making a will or wills.

Other methods of transmitting assets to beneficiaries are also uncertain. Owning assets in joint tenancy with heirs is essentially giving property away while still alive; there are potential tax and legal problems. In addition, if the heir/heirs should predecease his/her/their benefactor or benefactors, or die simultaneously, then the asset may be subject to probate under the terms of the beneficiary's will, or the rules of intestate descent.

Likewise beneficiarizing assets, which is when an individual or married couple, anticipating his/her/their decease, assigns a pay on death, transfer on death, or holds property in trust for his/her/their beneficiary or beneficiaries, does not fix costs of inheritance. Many people require legal help to obtain control of assets to which they are entitled, and, as above, beneficiarizing assets generally does not solve the potential problem of an heir predeceasing or dying simultaneously with his or her benefactor.

The use of trusts, both revocable and irrevocable, to bequeath assets likewise does not fix costs. Trusts may reduce costs, as trusts generally avoid probate, but trusts must be settled as well.

Thus, currently, no individual or married couple, anticipating his/her/their demise, is capable of fixing the cost by pre-agreement of transferring the assets of which their estate is comprised, to his/her/their heirs, after that demise.

### BACKGROUND OF THE INVENTION—ADVANTAGES

My remedy for this situation is to provide a method of contracting between individuals or married couples anticipating his/her/their demise and also anticipating leaving after his/her/their demise a bequeathable estate, between themselves and an individual, partnership or business entity qualified to settle the estate. Payment for settlement could be made in advance, or a combination of advance payment and a fixed post-mortem payment, or even all payment being made post-mortem according to a predetermined percentage or hourly rate. The buyer or buyers of the plan may be required to hold assets in non-probatable form, so that the future cost of settling the estate may be minimized and also pre-determined with greater accuracy.

If such a method is employed, then the cost of settling estates can be essentially guaranteed by the qualified individual, partnership or business entity offering settlement. The only uncertainty remaining for the buyer of such a service would be the payment of estate taxes. Since the exemption for federal estate taxes is currently one million dollars per individual, and rising, and many states do not have inheritance taxes, this method could fix a cost exactly to settle most middle-class estates.

Prior art for this invention, as far as I can determine, does not exist, or is of such a nature that it does not preclude this application. Prepaid burial plans are offered, but they only fix the cost of disposing of the deceased's remains.

1. A method of transferring assets from deceased persons to their beneficiaries, a pre-agreed estate settlement plan, comprising:
(a) Any contract/contracts between any person or married couple anticipating his/her/their demise and any individual, partnership or business entity capable of transferring and/or assisting in the transfer of said individual or married couple's estate after that demise, so that it becomes the legal property of said person or married couple's heir or heirs, according to said person or married couple's instructions, for a fixed sum or sums, and/or according to a fixed schedule of costs and/or a pre-agreed percentage of assets, whereby said person or married couple can predetermine and/or reduce the cost of transferring his/her/their estate to his/her/their heirs.
(1) Because of the substantial uncertainty of probate costs and difficulty, which vary from state to state, the process may include requirements for the person or married couple entering into said process to own assets in a non-probatable fashion, such as a revocable and/or irrevocable trust or trusts, and/or joint tenancy with potential heirs and/or designating assets as being held “in trust for” potential heirs and/or instructing financial institutions with which they do business to maintain their accounts under a “pay on death” or “transfer on death” designation to potential heirs, or any other method of qualifying assets so that they are not subject to probate.
(2) Such process may include the agreement of the heir/heirs or any legal entity such as a trust that such heirs may anticipate control over, as well as the person or married couple who anticipates being their benefactors to said process, in order to make them aware of the benefits of the process and also to assure both the heir/heirs and the person or married couple entering into the process that they have legal recourse should the individual, partnership or business entity that they have contracted with to settle the estate in question fail to perform according to the terms of said agreement.
